(19) United States
(12) Patent Application Publication
(10) Pub. No.: US 2020/0104160 A1
(43) Pub. Date: Apr. 2, 2020

(54) EVALUATING TARGETING CONDITIONS FOR A/B TESTS

(71) Applicant: Microsoft Technology Licensing, LLC, Redmond, WA (US)

(72) Inventors: Alexander Ivaniuk, Sunnyvale, CA (US); Jingbang Liu, Cupertino, CA (US)

(73) Assignee: Microsoft Technology Licensing, LLC, Redmond, WA (US)

(21) Appl. No.: 16/146,725

(22) Filed: Sep. 28, 2018

(51) Int. Cl. G06F 9/48; G06F 17/30; G06Q 30/02

(52) U.S. Cl. CPC G06F 9/4812; G06F 17/30469; G06Q 30/0201; G06F 17/30489; G06F 17/30864

(57) ABSTRACT

The disclosed embodiments provide a system for evaluating targeting conditions for A/B tests. During operation, the system obtains a test configuration containing targeting conditions for an A/B test, wherein the targeting conditions include attributes of one or more segments of users and operators to be applied to the attributes. Next, the system identifies an operator between a first targeting condition that can be evaluated locally and a second targeting condition that requires a remote call to evaluate. The system then evaluates the first targeting condition without evaluating the second targeting condition to produce an output value of the first targeting condition. When application of the operator to the output value produces a Boolean value, the system returns the Boolean value as an evaluation result for a portion of the test configuration represented by the operator, the first targeting condition, and the second targeting condition.

### BACKGROUND

### Field

The disclosed embodiments relate to A/B testing. More specifically, the disclosed embodiments relate to techniques for evaluating targeting conditions for A/B tests.

### Related Art

A/B testing, or controlled experimentation, is a standard way to evaluate user engagement or satisfaction with a new service, feature, or product. For example, a company may use an A/B test to show two versions of a web page, email, article, social media post, layout, design, and/or other information or content to users to determine if one version has a higher conversion rate than the other. If results from the A/B test show that a new treatment version performs better than an old control version by a certain amount, the test results may be considered statistically significant, and the new version may be used in subsequent communications or interactions with users already exposed to the treatment version and/or additional users.

A/B testing techniques commonly involve defining segments of users to target with A/B tests, as well as subsequent assignment of users in each segment to the treatment and control versions. For example, a segment of users may be defined based on demographic attributes such as location, language, age, education, profession, occupation, and/or income level; behavioral attributes such as views, user sessions, level of engagement, searches, and/or features used; and/or platform-specific attributes such as operating system, application type (e.g., mobile, native, web, etc.), and/or application version. The segment may also include a distribution of treatment assignments in a corresponding A/B test (e.g., 50% treatment and 50% control, 10% treatment and 90% control, 100% treatment, etc.). In turn, the segment may be defined to include certain users and/or exclude certain users, as well as control the exposure of the users to the treatment version of an A/B test.

Consequently, fine-grained and/or intelligent segmentation of users in A/B tests may improve the accuracy, performance, and/or flexibility of A/B testing techniques.

### BRIEF DESCRIPTION OF THE FIGURES

FIG. 1 shows a schematic of a system in accordance with the disclosed embodiments.

FIG. 2 shows a system for performing A/B testing in accordance with the disclosed embodiments

FIG. 3 shows an example representation of targeting conditions for an A/B test in accordance with the disclosed embodiments.

FIG. 4 shows a flowchart illustrating a process of evaluating targeting conditions for an A/B test in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing A/B testing. During an A/B test, one set of users may be assigned to a treatment group that is exposed to a treatment variant, and another set of users may be assigned to a control group that is exposed to a control variant. The users' responses to the exposed variants may then be monitored and used to determine if the treatment variant performs better than the control variant.

More specifically, the disclosed embodiments provide a method, apparatus, and system for evaluating targeting conditions for A/B tests. The targeting conditions may include user attributes, platform attributes, and/or custom attributes that are used to define segments of users to be included in the A/B tests, as well as operators that are to be applied to values of the attributes. For example, an A/B test may include one or more segments of users, with each segment defined to include or exclude users based on attributes such as the users' countries, languages, locales, industries, operating systems, application types (e.g., mobile, native, web, etc.), and/or application versions. Each segment may further specify a distribution of treatment assignments in the A/B test, such as 50% treatment and 50% control, 10% treatment and 90% control, and/or 100% treatment.

During evaluation of targeting conditions for an A/B test, higher-latency remote calls for retrieving attribute values are reduced by trying to resolve user assignments to segments from targeting conditions that can be resolved locally before evaluating targeting conditions that require remote calls to resolve. Similarly, targeting conditions for fully ramped A/B tests and/or targeting conditions that always evaluate to the same treatment assignment may be simplified to always return the treatment assignment. Type safety of the targeting conditions is further improved by converting types in the targeting conditions to a minimal set of types that can be compared and performing subsequent type validation of the converted types.

By evaluating targeting conditions for A/B tests in an efficient, type-safe manner, the disclosed embodiments may reduce latency and/or errors in performing user segmentation and/or generating treatment assignments during A/B testing. In contrast, conventional techniques for targeting and/or segmenting users may involve manually generating code for processing targeting conditions and/or segmenting users for individual A/B tests. Consequently, the disclosed embodiments may provide technological improvements related to the development and use of computer systems, applications, services, and/or workflows for performing A/B testing, user segmentation, and/or user targeting.

### Evaluating Targeting Conditions for A/B Tests

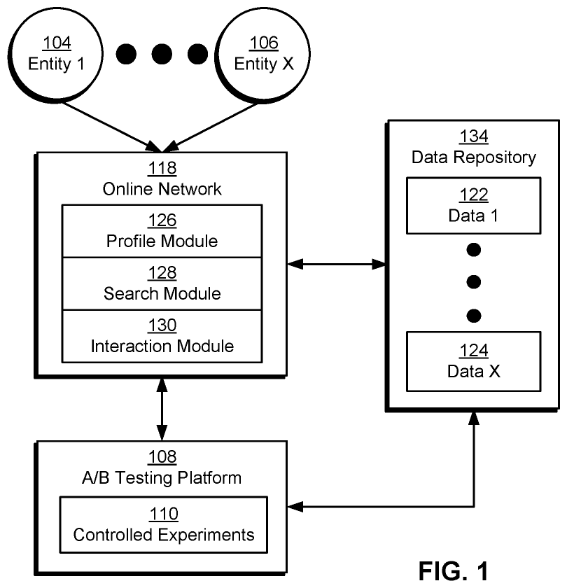

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

In turn, data in data repository 134 may be used by an A/B testing platform 108 to conduct controlled experiments 110 of features in online network 118. Controlled experiments 110 may include A/B tests that expose a subset of the entities to a treatment variant of a message, feature, and/or content. For example, A/B testing platform 108 may select a random percentage of users for exposure to a new treatment variant of an email, social media post, feature, offer, user flow, article, advertisement, layout, design, and/or other content during an A/B test. Other users in online network 118 may be exposed to an older control variant of the content.

During an A/B test, entities affected by the A/B test may be exposed to the treatment or control variant, and the entities' responses to or interactions with the exposed variants may be monitored. For example, entities in the treatment group may be shown the treatment variant of a feature after logging into online network 118, and entities in the control group may be shown the control variant of the feature after logging into online network 118. Responses to the control or treatment variants may be collected as clicks, views, searches, user sessions, conversions, purchases, comments, new connections, likes, shares, and/or other performance metrics representing implicit or explicit feedback from the entities. The metrics may be aggregated into data repository 134 and/or another data-storage mechanism on a real-time or near-real-time basis and used by A/B testing platform 108 to compare the performance of the treatment and control variants.

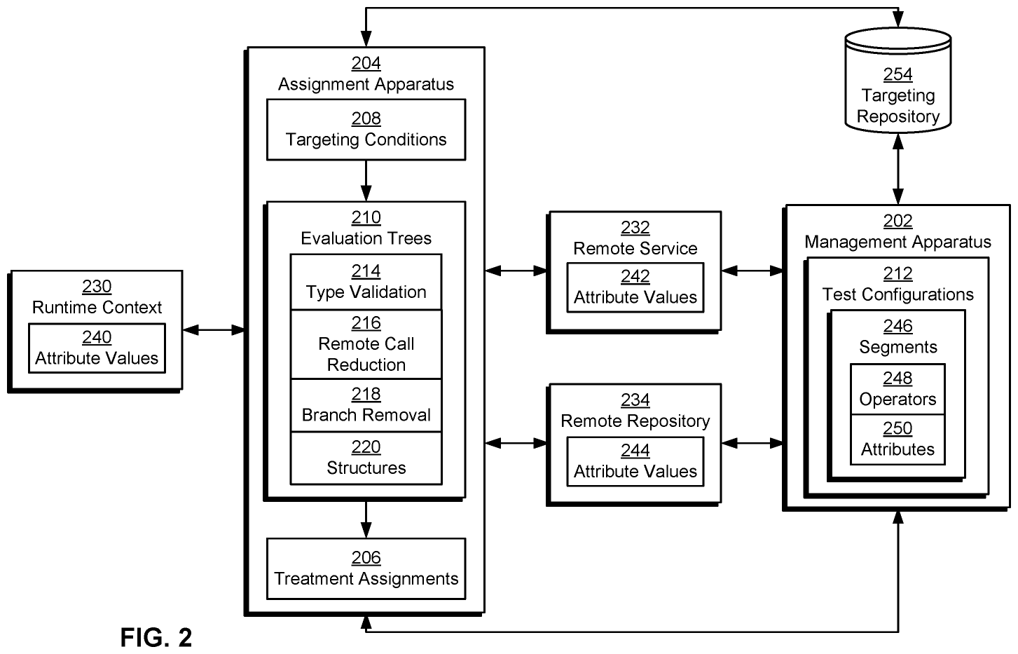

As shown in FIG. 2, a system for performing A/B testing (e.g., A/B testing platform 108 of FIG. 1) includes a management apparatus 202 and an assignment apparatus 204. Each of these components is described in further detail below.

Management apparatus 202 handles the definition, registration, and/or onboarding of data used to perform A/B tests. In turn, assignment apparatus 204 uses the data to generate treatment assignments 206 of users in the A/B tests.

First, management apparatus 202 obtains test configurations 212 that are used to set up A/B tests in the A/B testing platform. For example, management apparatus 202 may provide a user interface that allows a user to specify and/or select parameters of a test configuration. In another example, management apparatus 202 may obtain a test configuration that is defined using a domain-specific language (DSL) associated with the A/B testing platform.

Test configurations 212 may include criteria for targeting users with the corresponding A/B tests. Each test configuration may specify one or more segments 246 of users for inclusion in a corresponding A/B test. In addition, each segment may be defined to include or exclude attributes 250 of the corresponding users.

For example, attributes 250 may include user profile attributes such as a whitelist of user IDs and/or the users' names, registration dates, graduation years, locations, industries, positions, companies, schools, languages, occupations, and/or account types (e.g., free, paid, premium, etc.). Attributes 250 may also indicate the presence or absence of profile pictures, summaries, endorsements, and/or other fields in the users' profiles (e.g., with an online network and/or website). In another example, attributes 250 may include platform-specific attributes, such as the operating systems, application types (e.g., mobile, web, native, etc.), application names, application versions, devices, network connection types (e.g., cellular, wired, wireless, etc.), and/or other characteristics of hardware and/or software used by the users to access or use the treatment and/or control variants in the A/B test. In a third example, attributes 250 may include usage attributes such as metrics related to the users' number of sessions, duration of sessions, clicks, views, posts, likes, searches, connection requests, messages, and/or other types of activity with an online network and/or website on which the A/B test is run. In a fourth example, attributes 250 may include custom attributes that are defined and onboarded using user-specified attribute configurations.

Each segment may also include one or more operators 248 that are used to evaluate the corresponding attributes 250. Operators 248 may include logical operators (e.g., and, or, xor, xnor, not, etc.), comparison operators (e.g., equals, does not equal, greater than, less than, greater than or equal to, less than or equal to, etc.), and/or inclusion operators (e.g., includes, excludes, etc.). Together, operators 248 and attributes 250 may form targeting conditions 208 that are subsequently used by assignment apparatus 204 to identify a segment to which a user belongs in an A/B test.

Test configurations 212 may further specify distributions or allocations of treatment assignments 206 within segments 246 of each A/B test. For example, a test configuration may specify that users in a segment be assigned to the treatment and control groups of an A/B test according to a 50/50 split between treatment and control. In another example, a test configuration may indicate assignment of 10% of users in a segment to the treatment group and assignment of 90% of users in the same segment to the control group. In a third example, a test configuration may specify a “default” assignment of 100% of users that cannot be placed into other segments of an A/B test to the control group of the A/B test.

An example test configuration may include the following representation:
(ab(=(country-code)(value “US”))[treatment 50]
(It (connection-count)(value 100))[treatment 20]
(all)[control 100))
   The representation includes a first targeting condition that applies an equality operator to an attribute named “country-code” and a value of “US.” The representation specifies that 50% of users that belong to the segment represented by the first targeting condition (i.e., users with a “country-code” attribute value that equals “US”) should be assigned to the treatment group of an A/B test. In turn, the remaining 50% of users may be assigned to the control group of the same A/B test.

The representation also includes a second targeting condition that applies a “less than” comparison operator to an attribute named “connection-count” and a value of 100. The representation indicates that 20% of users that belong to the segment represented by the second targeting condition (i.e., users with a “connection-count” attribute value that is less than 100) should be assigned to the treatment group of the A/B test.

Finally, the representation includes a default segment of “all” that is applied to all users that do not belong to the other two segments in the test configuration (e.g., users with “country-code” attribute values that do not equal “US” and with “connection-count” attribute values that are not less than 100). The representation specifies that 100% of users that belong in the default segment be assigned to the control group of the A/B test.

After test configurations 212 are obtained from and/or provided by users, management apparatus 202 stores test configurations 212 in a targeting repository 254. Assignment apparatus 204 and/or other components of the system may subsequently retrieve test configurations 212 from targeting repository 254 and use the retrieved test configurations 212 to generate treatment assignments 206 for the users in the corresponding A/B tests.

Second, management apparatus 202 configures the onboarding and/or retrieval of attribute values 242-244 of attributes 250 specified in test configurations 212. For example, management apparatus 202 may obtain attribute definitions such as names, descriptions, attribute types (e.g., string, Boolean, number, long, double, date, test version, string collection, number collection, etc.), entity types (e.g., users, companies, contracts, and/or other entities described by the attribute), and/or owners (e.g., a user or team that is responsible for generating the attribute) of attributes 250. Management apparatus 202 may also identify and/or locate data sources representing remote environments, data stores, services (e.g., remote service 232), repositories (e.g., remote repository 234), tools, and/or other mechanisms for accessing attribute values 242-244 of attributes 250. In turn, management apparatus 202 may transmit the locations of the data sources to assignment apparatus 204 and/or other components of the system and/or otherwise configure the components to retrieve attribute values 242-244 from the data sources.

Assignment apparatus 204 uses test configurations 212 from targeting repository 254 and/or management apparatus 202 and attribute values 240-244 for a set of entities to perform targeting of the entities with the A/B tests. More specifically, assignment apparatus 204 obtains targeting conditions 208 for one or more segments 246 of an A/B test from targeting repository 254 and/or management apparatus 202. Next, assignment apparatus 204 matches attributes 250 in targeting conditions 208 to attribute values 240-244 of the corresponding entities from one or more data sources.

Assignment apparatus 204 then applies targeting conditions 208 to the retrieved attribute values 240-244 to generate treatment assignments 206 for one or more users in an A/B test. For example, assignment apparatus 204 may apply targeting conditions 208 for segments 246 in an A/B test in the order in which segments 246 are declared in the test configuration for the A/B test. In turn, assignment apparatus 204 may assign the user to the first segment in which the user's attribute values evaluate to true using the corresponding targeting conditions 208. Assignment apparatus 204 may then select a treatment assignment for the user based on the distribution of treatment assignments 206 for the corresponding segment.

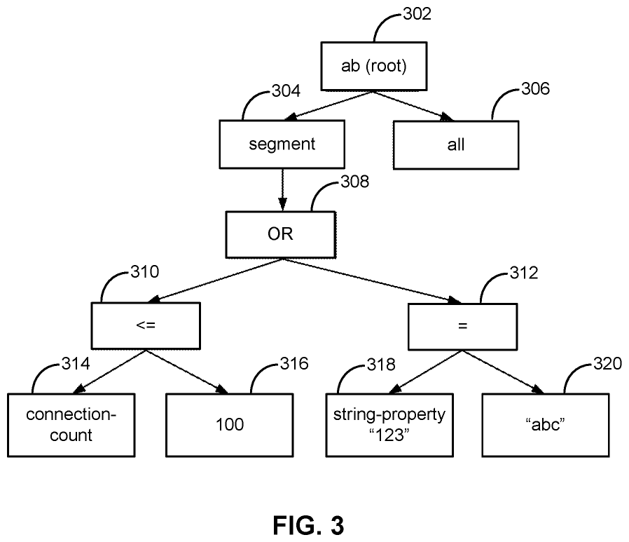

As shown in FIG. 2, assignment apparatus 204 uses evaluation trees 210 to apply targeting conditions 208 to one or more sets of attribute values (e.g., attribute values 240-244). Evaluation trees 210 may include tree- or graph-based representations of targeting conditions 208. For example, attributes 250 in targeting conditions 208 that define one or more segments 246 of users in an A/B test may be represented using leaf nodes in a corresponding evaluation tree, and operators 248 in targeting conditions 208 may be represented using parent nodes of the leaf nodes in the evaluation tree. A root node of the evaluation tree may represent the evaluation result for the set of targeting conditions 208, which is used to select a segment in the A/B test to which a user belongs. Evaluation trees for targeting conditions are described in further detail below with respect to FIG. 3.

Prior to and/or during evaluation of nodes in evaluation trees 210, assignment apparatus 204 may perform type validation 214 of data types represented by nodes in evaluation trees 210. To improve the performance of type validation 214, assignment apparatus 204 may convert a first set of types in targeting conditions 208 and/or the corresponding evaluation trees 210 into a second set of types. For example, assignment apparatus 204 may convert integer types in targeting conditions 208 and/or evaluation trees 210 to long types. Assignment apparatus 204 may also, or instead, convert float types in targeting conditions 208 and/or evaluation trees 210 to double types. As a result, assignment apparatus 204 may merge similar types in targeting conditions 208 and/or evaluation trees 210 into a smaller, minimal set of types (e.g., string, long, double, Boolean, date, collection, etc.) that can be compared with one another to ensure type safety in targeting conditions 208.

Assignment apparatus 204 may also, or instead, reduce type ambiguity associated with user-defined “custom” attributes in targeting conditions 208. For example, assignment apparatus 204 may obtain an attribute definition for a custom attribute from management apparatus 202 and/or another data source and use an attribute type in the attribute definition as the data type of the node representing the attribute in an evaluation tree. In another example, assignment apparatus 204 may identify the type of a custom attribute based on a user-defined “selector” for the custom attribute that is strongly typed (e.g., a selector that explicitly has a long, double, Boolean, string, date, collection of long, and/or collection of string type).

Assignment apparatus 204 may then perform type validation 214 using the converted and/or resolved types. During type validation 214, assignment apparatus 204 may use a specification for each type of operator and/or attribute in targeting conditions 208 to validate types of one or more attributes inputted into the operator and/or validate a return type of the operator. Such specifications may be defined to have varying ranges of inclusivity in acceptable input types and/or return types. For example, a “custom” operator may be defined to return a broad variety of types (e.g., long, double, Boolean, or string). Conversely, a logical disjunction operator may be defined to accept only Boolean input types and return only a Boolean return type.

More specifically, assignment apparatus 204 may use definitions and/or specifications for attributes represented by leaf nodes of an evaluation tree to identify return types for the attributes. Assignment apparatus 204 may then proceed upward from the leaf nodes and verify that the return types of the leaf nodes are compatible with the input types of operators represented by parent nodes of the leaf nodes, based on overloads of the operators included in the specifications for the operators. Assignment apparatus 204 may continue iterating comparing the return types of a level of child nodes in the evaluation tree with the input types of the corresponding parent nodes until the root node of the evaluation tree is reached.

For example, assignment apparatus 204 may perform type validation 214 by verifying that two attributes inputted into an equality operator (e.g., “=”) have the same type. In another example, assignment apparatus 204 may verify that a Boolean type of the equality operator's output value can be used as an input type for another operator (e.g. a logical operator) represented by a parent node of the equality operator in an evaluation tree. In a third example, assignment apparatus 204 may identify an invalid targeting condition when an inclusion operator that is defined to determine if a value of a first attribute is found in a second attribute with the same type or a collection of the same type as the first attribute is applied to a first attribute type of “long” and a second attribute type of “StringCollection.”

If a set of targeting conditions 208 passes type validation 214, assignment apparatus 204 may resolve the values of child nodes in a corresponding evaluation tree by retrieving the corresponding attribute values (e.g., attribute values 240-244) from runtime context 230, remote service 232, and/or remote repository 234. Assignment apparatus 204 may input the attribute values as arguments to parent nodes representing operators 248 in targeting conditions 208 to produce additional values representing the output of operators 248. Assignment apparatus 204 may continue inputting values associated with child nodes into operators 248 represented by parent nodes of the child nodes until an output value for the root node of the evaluation tree is obtained.

As mentioned above, input to targeting conditions 208 and/or evaluation trees 210 may include one set of attribute values 240 in a runtime context 230 that is passed to assignment apparatus 204, another set of attribute values 242 from remote service 232, and/or a third set of attribute values 244 from remote repository 234. Runtime context 230 may be obtained from a request and/or trigger to generate treatment assignments 206 for one or more users or entities. For example, runtime context 230 may be passed to assignment apparatus 204 when the user(s) log in to a platform and/or use a feature that is being A/B tested. In another example, runtime context 230 may be generated and passed to assignment apparatus 204 when batch processing of treatment assignments 206 by assignment apparatus 204 is triggered.

Runtime context 230 may include a number of attributes values 240 that can be used with targeting conditions 208. For example, attribute values 240 may include entity keys (e.g., user IDs, company IDs, contract IDs, etc.) for one or more entities to be targeted by an A/B test; platform-specific attributes (e.g., operating systems, application versions, application types, device types, network connection types, etc.) of platforms used by the entities; and/or contexts associated with the entities (e.g., advertising campaigns, if a user is online or not, latest user action, etc.). In general, an owner of an A/B test may configure and/or customize a set of attribute values 240 that is included in runtime context 230 when assignment apparatus 204 is called and/or triggered to generate one or more treatment assignments 206 for the corresponding entities.

Remote service 232 may provide attribute values 242 for attributes 250 on a real-time basis. For example, remote service 232 may be a Representational State Transfer (REST) and/or other type of service that returns the latest attribute values 242 in response to requests for the corresponding attributes 250. Attribute values 242 provided by remote service 232 may include, but are not limited to, user profile attributes (e.g., name, email address, industry, position, company, school, graduation year, language, account type); metrics or flags related to the user profile attributes (e.g., number of connections, number of new connections, number of schools, number of positions, number of profile views, presence of profile picture, presence of summary, etc.); and/or metrics related to the user's activity (e.g., most recent user session, average session length, average session frequency, level of engagement, recent use of features, etc.).

Remote repository 234 may provide attribute values 244 that are aggregated from one or more data sources and/or environments. For example, remote repository 234 may include attribute values 244 that are aggregated from an offline environment containing a distributed data store such as Hadoop Distributed File System (HDFS), which creates and/or updates attributes 250 on an hourly and/or daily basis. Remote repository 234 may also, or instead, include attribute values 244 that are aggregated from a near-real-time environment containing one or more event streams that transmit records of recently created and/or updated attributes 250. Attribute values 244 in remote repository 234 may include “custom” attributes that are defined and/or created by owners of A/B tests.

Those skilled in the art will appreciate that different latencies may be involved in retrieving attribute values 240-244 from runtime context 230, remote service 232, and remote repository 234. In turn, such latencies may affect the speed with which assignment apparatus 204 evaluates targeting conditions 208 and generates corresponding treatment assignments 206. For example, attribute values 240 that are included in runtime context 230 may be stored locally in memory on assignment apparatus 204, which may allow assignment apparatus 204 to evaluate targeting conditions 208 containing attribute values 240 in microseconds or less. On the other hand, attribute values 242-244 may be retrieved by performing higher-latency remote calls to remote service 232 and remote repository 234, respectively. As a result, assignment apparatus 204 may evaluate targeting conditions 208 that use attribute values 242-244 on the order of milliseconds instead of microseconds.

In one or more embodiments, assignment apparatus 204 improves latency associated with evaluating targeting conditions 208 and/or generating treatment assignments 206 by performing remote call reduction 216 during retrieval of attributes 240-244 used in evaluating targeting conditions 208. In these embodiments, remote call reduction 216 may include evaluating targeting conditions 208 and/or generating treatment assignments 206 in a way that reduces remote calls to remote service 232 and/or remote repository 234.

As mentioned above, assignment apparatus 204 may retrieve attribute values 240 from runtime context 230 with significantly lower latency than retrieving attribute values 242-244 from remote service 232 and/or remote repository 234. As a result, assignment apparatus 204 may expedite processing of an evaluation tree by avoiding remote calls to remote service 232 and/or remote repository 234 unless the calls are required to assign a user to a segment in an A/B test.

In one or more embodiments, assignment apparatus 204 performs remote call reduction 216 by identifying a logical operator between a first targeting condition that can be evaluated locally and a second targeting condition that requires a remote call to execute. For example, assignment apparatus 204 may identify the first targeting condition as a first sub-tree of an evaluation tree that can be evaluated using one or more attribute values 240 in runtime context 230 and the second targeting condition as a second sub-tree of the same evaluation tree that is evaluated using attribute values 242-244 from remote service 232 and/or remote repository 234. The first and second sub-trees may be connected by a parent node representing a binary logical operator, such as a logical conjunction operator or a logical disjunction operator.

Next, assignment apparatus 204 may evaluate the first targeting condition without evaluating the second targeting condition to produce an output value for the first targeting condition. Continuing with the above example, assignment apparatus 204 may apply one or more operators to one or more attribute values 240 in the first sub-tree to generate an output value of the first sub-tree.

When application of the logical operator to the output value of the first targeting condition produces a Boolean value, assignment apparatus 204 may return the Boolean value as an evaluation result for a portion of the evaluation tree represented by the logical operator and the two sub-trees. Continuing with the above example, assignment apparatus 204 may apply the logical operator to a Boolean output value for the first sub-tree. When the logical operator is a logical conjunction operator that is applied to a false output value for the first sub-tree, the logical operator may produce a false value. When the logical operator is a logical disjunction that is applied to a true output value for the first sub-tree, the logical operator may produce a true value. As a result, assignment apparatus 204 may return the true or false value produced by combining the logical operator with the first sub-tree without evaluating the second sub-tree to avoid unnecessary remote calls required to retrieve attribute values (e.g., attribute values 242-244) used to evaluate the second sub-tree.

To further expedite processing of targeting conditions 208, assignment apparatus 204 may perform branch removal 218 in portions of evaluation trees 210 that always produce the same output value. For example, assignment apparatus 204 may identify a fully ramped A/B test when a test configuration for the A/B test assigns 100% of users in all segments to the treatment group of the A/B test. To reduce unnecessary processing and/or retrieval of attribute values (e.g., attribute values 240-244) associated with evaluating nodes representing targeting conditions 208 for the A/B test, assignment apparatus 204 may replace the nodes with a single node that always returns an assignment to the treatment group. In another example, assignment apparatus 204 may identify a sub-tree of an evaluation tree that always evaluates to the same output value and replace the sub-tree with a node that always returns the same output value.

Assignment apparatus 204 may further store representations of evaluation trees 210 in a way that improves caching and/or reading of evaluation trees 210 from memory. For example, assignment apparatus 204 may store an evaluation tree in three arrays. The first array may contain identifiers for nodes in the evaluation tree, with child nodes of any given node placed in contiguous elements of the array. The second array may contain “child counts” of nodes with the same indexes in the first array, and the third array may contain “child offset indices” of the corresponding nodes in the first array. A node's children in the evaluation tree may be obtained as elements of the first array that start at the node's “child offset indices” in the second array and proceed for the number of indexes represented by the node's “child counts” in the third array. In turn, reading of the evaluation tree from memory may cause some or all bytes in the arrays to be loaded into a processor cache, which may expedite subsequent access to the evaluation tree (e.g., during evaluation of targeting conditions 208 represented by the evaluation tree).

By evaluating targeting conditions 208 for A/B tests in an efficient, type-safe manner, the system of FIG. 2 may reduce latency and/or errors in performing user segmentation and/or generating treatment assignments during A/B testing. In contrast, conventional techniques for targeting and/or segmenting users may involve manually generating code for processing targeting conditions and/or segmenting users for individual A/B tests. Consequently, the disclosed embodiments may provide technological improvements related to the development and use of computer systems, applications, services, and/or workflows for performing A/B testing, user segmentation, and/or user targeting.

Those skilled in the art will appreciate that the system of FIG. 2 may be implemented in a variety of ways. First, management apparatus 202, assignment apparatus 204, targeting repository 254, remote service 232, and/or remote repository 234 may be provided by a single physical machine, multiple computer systems, one or more virtual machines, a grid, one or more databases, one or more filesystems, and/or a cloud computing system. Management apparatus 202 and assignment apparatus 204 may additionally be implemented together and/or separately by one or more hardware and/or software components and/or layers.

Second, test configurations 212, attribute values 240-244, and/or other data used by the system may be obtained from and/or persisted in a number of data sources. As mentioned above, the data sources may include offline data stores, near-real-time event streams, and/or real-time services (e.g., remote service 232). In turn, data from the data sources may be stored in repositories such as HDFS, Structured Query Language (SQL) databases, key-value stores, and/or other types of data stores. One or more repositories (e.g., remote repository 234, targeting repository 254, etc.) may further be replicated, merged, and/or omitted to accommodate requirements or limitations associated with the processing, performance, scalability, and/or redundancy of the system.

Third, the system may be adapted to various types of experiments and/or hypothesis tests. For example, the system of FIG. 2 may be used to assign users to different groups and/or cohorts in A/B tests, studies, and/or other types of research designs for different features and/or versions of websites, social networks, applications, platforms, advertisements, recommendations, and/or other hardware or software components that impact user experiences.

FIG. 3 shows an example representation of targeting conditions for an A/B test in accordance with the disclosed embodiments. More specifically, FIG. 3 shows an evaluation tree representing a set of targeting conditions for a segment of an A/B test. The evaluation tree includes a set of nodes 302-320, with leaf nodes 314-320 representing attribute values and parent nodes 302-312 of leaf nodes 314-320 representing operators that are applied to the attribute values and/or output values of other operators.

An in-memory representation of the evaluation tree may include the following:

| | Index | | | | | | | | | |
|---|---|---|---|---|---|---|---|---|---|---|
| | 0 | 1 | 2 | 3 | 4 | 5 | 6 | 7 | 8 | 9 |
| Node | ab | segment | all | OR | <= | = | connection- | 100 | string- | “abc” |
| | (root) | | | | | | count | | property | |
| | | | | | | | | | “123” | |
| ChildCount | 2 | 1 | | 2 | 2 | 2 | | | | |
| ChildOffsetIndex | 1 | 3 | | 4 | 6 | 8 | | | | |

The representation above includes three arrays that are indexed from 0 to 9. Index 0 represents node 302, index 1 represents node 304, index 2 represents node 306, index 3 represents node 308, index 4 represents node 310, index 5 represents node 312, index 6 represents node 314, index 7 represents node 316, index 8 represents node 318, and index 9 represents node 320. Each element of the “Node” array stores an identifier and/or name of a corresponding attribute, value, and/or operator. Each element of the “ChildCount” array stores the number of children of the node represented by the corresponding index. Each element of the “ChildOffsetIndex” array stores the offset of the first child of the node represented by the corresponding index. As a result, the representation may reduce the memory consumed by the evaluation tree and/or facilitate subsequent loading of the evaluation tree into a processor cache (e.g., when nodes in the evaluation tree are read from memory).

A root node 302 of the evaluation tree represents the evaluation result of the targeting conditions, and two child nodes 304-306 of node 302 represent two segments in the A/B test. As mentioned above, nodes 302-320 in the evaluation tree may be evaluated according to the order in which segments in the targeting conditions were declared, so that an entity is assigned to the first segment for which the corresponding targeting conditions evaluate to true. As a result, a first sub-tree with a root of node 304 may always be evaluated before a second sub-tree with a root of node 306.

During evaluation of the first sub-tree, a “<=” operator represented by node 310 may be applied to a “connection-count” attribute represented by node 314 and a value of “100” represented by node 316. The operator may return a value of “true” if the value of “connection-count” is less than or equal to 100 and a value of “false” otherwise.

Similarly, a “=” operator represented by node 312 may be applied to a ‘string-property “123”’ attribute represented by node 318 and another value of “abc” represented by node 320. The operator may return a value of “true” if the value of ‘string-property “123”’ is equal to “abc.”

An “OR” operator represented by node 308 may then be applied to the output of nodes 310-312 to generate a Boolean value that is passed to node 304, which represents a segment in the A/B test. As a result, an entity may belong in the segment when the output of node 308 is a true value. In turn, the segment may be returned as the evaluation result of the targeting conditions when node 308 returns a true value.

If the entity does not belong in the segment (e.g., when the output of node 308 is a false value), evaluation of the second sub-tree may be performed. Because the second sub-tree contains only one node 306 representing a default segment of “all” that includes all entities that do not belong to other segments in the targeting conditions (e.g., the segment represented by node 304), node 306 may always evaluate to true. In turn, the segment represented by node 306 may be returned as the evaluation result of the evaluation tree when node 304 does not return a true value.

To expedite processing of the targeting conditions, remote calls used to retrieve attribute values in leaf nodes 314-320 may be avoided and/or reduced. For example, a value of the “connection-count” attribute represented by node 314 may be retrieved by calling a remote service and/or querying a remote repository. On the other hand, a value of the ‘string-property “123”’ attribute represented by node 318 may be passed in a runtime context for evaluating the targeting conditions. As a result, a first sub-tree represented by nodes 312, 318 and 320 may be evaluated before a second sub-tree represented by nodes 310, 314 and 316.

The “OR” operator represented by node 308 may then be applied to the output of the first sub-tree to determine if an output value of the operator can be generated from only the output of the first sub-tree. In particular, the “OR” operator may return a true value if the output of the first sub-tree is a true value (e.g., when the value of ‘string-property “123”’ equals “abc”). When the output value of the “OR” operator can be resolved using the output of only the first sub-tree, evaluation of the second sub-tree may be omitted, thus avoiding additional latency associated with making a remote call to retrieve the value of the “connection-count” attribute.

The evaluation tree of FIG. 3 may further be simplified when the A/B test is fully ramped. For example, the A/B test may be fully ramped when both segments represented by nodes 304-306 have allocations of 100% of entities to the treatment group of the A/B test. In turn, the evaluation tree may be simplified into a single segment with a 100% treatment allocation that always returns true to avoid unnecessary evaluation of nodes 304-320 that return the same result.

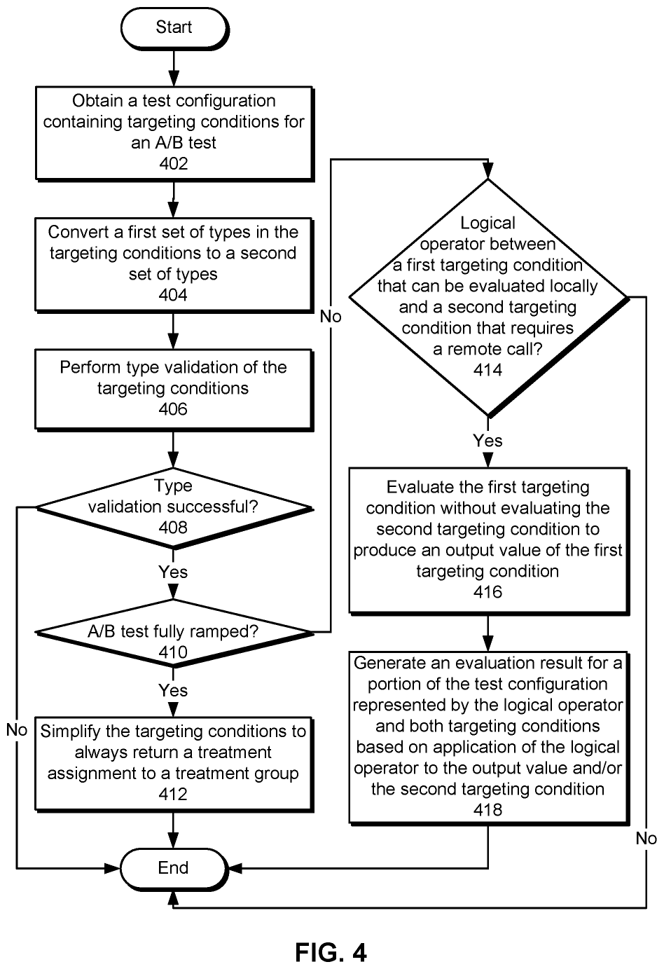

FIG. 4 shows a flowchart illustrating a process of evaluating targeting conditions for an A/B test in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a test configuration containing targeting conditions for an A/B test is obtained (operation 402). The targeting conditions may include attributes of one or more segments of users and operators to be applied to the attributes. For example, the test configuration may include a set of segments that are defined and/or ordered sequentially, such that a user is assigned to the first segment in which the user's attribute values evaluate to true using the corresponding targeting conditions.

Next, a first set of types in the targeting conditions is converted into a second set of types (operation 404), and type validation of the targeting conditions is performed (operation 406) based on the converted types. For example, type conversion may be performed by assigning a type to a custom selector for an attribute in the targeting conditions, converting an integer type to a long type, and/or converting a float type to a double type. Type validation may then be performed by validating types of one or more attributes inputted into each operator in the targeting conditions and/or validating a return type of the operator.

Subsequent processing of the test configuration may be processed based on the success or failure of the type validation (operation 408). If the type validation is unsuccessful, subsequent processing of the test configuration is discontinued, and a type validation error may optionally be outputted to allow a creator of the test configuration to fix type issues in the targeting conditions.

If the type validation is successful, the targeting conditions are evaluated based on a full ramping of the A/B test (operation 410). For example, the A/B test may be fully ramped when the A/B test has a 100% allocation to the treatment group of the A/B test for all segments in the test configuration. If the A/B test is fully ramped, the targeting conditions are simplified to always return a treatment assignment to a treatment group (operation 412) for all users and/or entities evaluated using the targeting conditions.

If the A/B test is not fully ramped, the targeting conditions may be evaluated to generate an evaluation result representing a segment to which a user belongs. During evaluation of the targeting conditions, a logical operator between a first targeting condition that can be evaluated locally and a second targeting condition that requires a remote call may be identified (operation 414). For example, the logical operator may include a logical conjunction operator or a logical disjunction operator that is applied to two targeting conditions with Boolean output values. The first targeting condition may be evaluated using attribute values that are passed in a runtime context, while the second targeting condition may be evaluated using attribute values that require higher latency remote calls to a service and/or repository. When the logical operator and corresponding pair of targeting conditions are not found in the test configuration, targeting conditions in the test configuration may be evaluated in a normal manner (e.g., according to the order in which the targeting conditions and/or corresponding segments were declared).

When the logical operator and corresponding targeting conditions are identified, the first targeting condition is evaluated without evaluating the second targeting condition to produce an output value of the first targeting condition (operation 416). An evaluation result for a portion of the test configuration represented by the logical operator and both targeting conditions is then generated based on application of the logical operator to the output value and/or the second targeting condition (operation 418). For example, a logical conjunction operator may be applied to a false output value for the first targeting condition to produce a false value as the evaluation result without evaluating the second targeting condition. In another example, a logical disjunction operator may be applied to a true output value for the first targeting condition to produce a true value as the evaluation result without evaluating the second targeting condition. In a third example, the second targeting condition may be evaluated when the logical operator cannot produce an evaluation result using just the output value of the first targeting condition, and the evaluation result may be obtained by applying the logical operator to the output values of both targeting conditions.

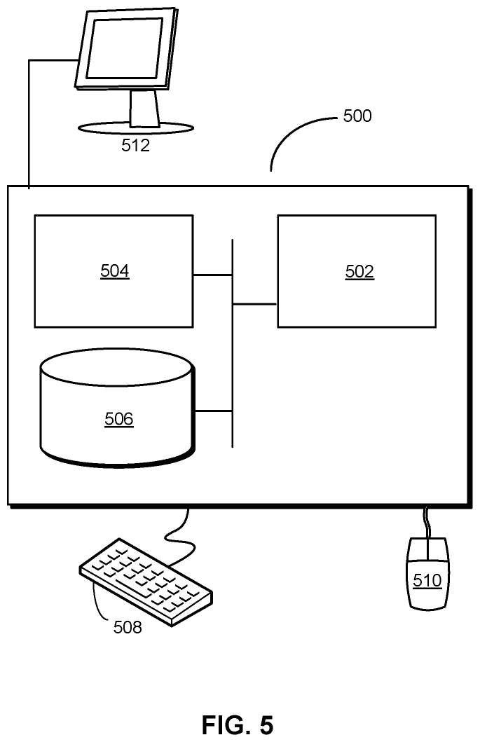

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the disclosed embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for evaluating targeting conditions for A/B tests. The system includes a management apparatus and an assignment apparatus, one or more of which may alternatively be termed or implemented as a module, mechanism, or other type of system component. The management apparatus obtains a test configuration containing targeting conditions for an A/B test. Next, the system identifies a logical operator between a first targeting condition that can be evaluated locally and a second targeting condition that requires a remote call to evaluate. The system then evaluates the first targeting condition without evaluating the second targeting condition to produce an output value of the first targeting condition. When application of the logical operator to the output value produces a Boolean value, the system returns the Boolean value as an evaluation result for a portion of the test configuration represented by the logical operator, the first targeting condition, and the second targeting condition.

In addition, one or more components of computer system 500 may be remotely located and connected to the other components over a network. Portions of the present embodiments (e.g., management apparatus, assignment apparatus, targeting repository, remote repository, remote service, online network, etc.) may also be located on different nodes of a distributed system that implements the embodiments. For example, the present embodiments may be implemented using a cloud computing system that evaluates targeting conditions for a set of remote users and/or remote A/B tests.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a first test configuration comprising targeting conditions for an A/B test, wherein the targeting conditions comprises attributes of one or more segments of users and operators to be applied to the attributes;
identifying, by a computer system based on the first test configuration, an operator between a first targeting condition that can be evaluated locally and a second targeting condition that requires a remote call to evaluate;
evaluating, by the computer system, the first targeting condition without evaluating the second targeting condition to produce an output value of the first targeting condition; and
when application of the operator to the output value produces a Boolean value, returning the Boolean value as an evaluation result for a portion of the first test configuration represented by the operator, the first targeting condition, and the second targeting condition.

2. The method of claim 1, further comprising:
identifying a second test configuration representing a fully ramped A/B test; and
simplifying additional targeting conditions for the second test configuration to always return a treatment assignment to a treatment group of the fully ramped A/B test.

3. The method of claim 2, wherein identifying the second test configuration representing the fully ramped A/B test comprises:
identifying a 100% allocation to the treatment group for all segments in the second test configuration.

4. The method of claim 1, wherein application of the operator to the output value of the first targeting condition comprises at least one of:
applying a logical conjunction operator to a false output value for the first targeting condition to produce a false value as the evaluation result; and
applying a logical disjunction operator to a true output value for the first targeting condition to produce a true value as the evaluation result.

5. The method of claim 1, further comprising:
converting a first set of types in the targeting conditions to a second set of types; and
performing, based on the second set of types, type validation of the targeting conditions prior to evaluating the first targeting condition.

6. The method of claim 5, wherein converting the first set of types to the second set of types comprises at least one of:
assigning a type to a custom selector for an attribute in the targeting conditions;
converting an integer type to a long type; and
converting a float type to a double type.

7. The method of claim 5, wherein performing type validation of the targeting conditions comprises:
validating types of one or more attributes inputted into an operator; and
validating a return type of the operator.

8. The method of claim 5, wherein the second set of types comprises at least one of:
a string type;
a long type;
a double type;
a Boolean type;
a date; and
a collection type.

9. The method of claim 1, wherein the remote call is performed with at least one of:
a service; and
a repository.

10. The method of claim 1, wherein the operators comprise at least one of:
a logical operator;
a comparison operator; and
an inclusion operator.

11. The method of claim 1, wherein the attributes comprise at least one of:
a user profile attribute;
a platform attribute; and
a custom attribute.

12. A system, comprising:
one or more processors; and
memory storing instructions that, when executed by the one or more processors, cause the system to:
obtain a first test configuration comprising targeting conditions for an A/B test, wherein the targeting conditions comprises attributes of one or more segments of users and operators to be applied to the attributes;
identify, based on the first test configuration, an operator between a first targeting condition that can be evaluated locally and a second targeting condition that requires a remote call to evaluate;
evaluate the first targeting condition without evaluating the second targeting condition to produce an output value of the first targeting condition; and
when application of the operator to the output value produces a Boolean value, return the Boolean value as an evaluation result for a portion of the first test configuration represented by the operator, the first targeting condition, and the second targeting condition.

13. The system of claim 12, wherein the memory further stores instructions that, when executed by the one or more processors, cause the system to:
identify a second test configuration representing a fully ramped A/B test; and
simplify additional targeting conditions for the second test configuration to always return a treatment assignment to a treatment group of the fully ramped A/B test.

14. The system of claim 12, wherein application of the operator to the output value of the first targeting condition comprises at least one of:
applying a logical conjunction operator to a false output value for the first targeting condition to produce a false value as the evaluation result; and
applying a logical disjunction operator to a true output value for the first targeting condition to produce a true value as the evaluation result.

15. The system of claim 12, wherein the memory further stores instructions that, when executed by the one or more processors, cause the system to:
convert a first set of types in the targeting conditions to a second set of types; and
perform, based on the second set of types, type validation of the targeting conditions prior to evaluating the first targeting condition.

16. The system of claim 15, wherein converting the first set of types to the second set of types comprises at least one of:
assigning a type to a custom selector for an attribute in the targeting conditions;
converting an integer type to a long type; and
converting a float type to a double type.

17. The system of claim 15, wherein performing type validation of the targeting conditions comprises:
validating types of one or more attributes inputted into an operator; and
validating a return type of the operator.

18. The system of claim 12, wherein the operators comprise at least one of:
a logical operator;
a comparison operator; and
an inclusion operator.

19. A non-transitory computer-readable storage medium storing instructions that when executed by a computer cause the computer to perform a method, the method comprising:
obtaining a first test configuration comprising targeting conditions for an A/B test, wherein the targeting conditions comprises attributes of one or more segments of users and operators to be applied to the attributes;
identifying, based on the first test configuration, an operator between a first targeting condition that can be evaluated locally and a second targeting condition that requires a remote call to evaluate;
evaluating the first targeting condition without evaluating the second targeting condition to produce an output value of the first targeting condition; and
when application of the operator to the output value produces a Boolean value, returning the Boolean value as an evaluation result for a portion of the first test configuration represented by the operator, the first targeting condition, and the second targeting condition.

20. The non-transitory computer-readable storage medium of claim 19, wherein the method further comprises:
converting a first set of types in the targeting conditions to a second set of types; and
performing, based on the second set of types, type validation of the targeting conditions prior to evaluating the first targeting condition.
